(19) United States
(12) Patent Application Publication
(10) Pub. No.: US 2026/0212243 A1
(43) Pub. Date: Jul. 23, 2026

(54) DRIVE CONTROLLER FOR QUBIT

(71) Applicant: IQM FINLAND OY, Espoo (FI)

(72) Inventors: Pasi LÄHTEENMÄKI, Espoo (FI); Jean-Luc ORGIAZZI, Espoo (FI); Olli-Pentti SAIRA, Espoo (FI)

(21) Appl. No.: 19/138,899

(22) PCT Filed: Dec. 13, 2022
(86) PCT No.: PCT/FI2022/050828

§ 371 Date: Jun. 13, 2025

(51) Int. Cl. G06N 10/40

(52) U.S. Cl. CPC G06N 10/40

(57) ABSTRACT

Example embodiments relate a drive controller for qubits of a quantum computer. An apparatus for driving at least one qubit may comprise: at least one drive circuit configured to receive a control data stream representing at least one gate sequence for the at least one qubit and generate a pulse sequence for the at least one qubit, the pulse sequence being based on the at least one gate sequence.

### TECHNICAL FIELD

Example embodiments generally relate to the field of quantum computers. In particular, some example embodiments relate to qubit control electronics.

### BACKGROUND

The power consumption of qubit control electronics is an obstacle to the scalability of quantum computers.

### SUMMARY

It is an objective to improve power efficiency of qubit control electronics in quantum computers. This and further benefits may be achieved by the features of the independent claims. Further advantageous implementation forms are provided in the dependent claims, the description, and the drawings.

Some embodiments improve scalability of quantum computers by improving the power efficiency of qubit control electronics.

Some embodiments improve the power efficiency of qubit control electronics without significantly limiting the gate speed.

Some embodiments provide a scalable cost and power consumption optimized room temperature apparatus for controlling at least one qubit with a binary signal.

According to a first aspect, an apparatus for driving at least one qubit comprises: at least one drive circuit configured to receive a control data stream representing at least one gate sequence for the at least one qubit and generate a pulse sequence for the at least one qubit, the pulse sequence being based on the at least one gate sequence.

In an example embodiment of the first aspect, the apparatus comprises a control circuit configured to generate the at least one control data stream.

In an example embodiment of the first aspect, the gate sequence is a sequence of gate elements from among a set of gate elements, wherein each gate element of the set of gate elements is represented by a corresponding data word in the at least one control data stream, and wherein each gate element is associated with one or more subsequences of pulses from among a set of subsequences of pulses.

In an example embodiment of the first aspect, the drive circuit is configured with the set of subsequences of pulses, and wherein the drive circuit is configured to identify, in the control data stream, the data word representing one of the gate elements, and generate the one or more subsequences of pulses associated with the gate element represented by the data word.

In an example embodiment of the first aspect, the gate sequence is a sequence of quantum gates from among a set of quantum gates, wherein each quantum gate of the set of quantum gates is represented by a corresponding data word in the at least one control data stream, and wherein each quantum gate is associated with a corresponding number of repetitions of one or more subsequences of pulses from among a set of subsequences of pulses.

In an example embodiment of the first aspect, the drive circuit is configured with the set of subsequences of pulses and the number of repetitions for each quantum gate, and wherein the drive circuit is configured to identify, in the control data stream, the data word representing one of the quantum gates, and generate the number of repetitions of the one or more subsequences of pulses associated with the quantum gate represented by the data word.

In an example embodiment of the first aspect, the gate sequence is a sequence of differential gates from among a set of differential gates, wherein each differential gate of the set of differential gates is represented by a corresponding data word in the at least one control data stream, and wherein each differential gate is associated with a corresponding subsequence of pulses from among a set of subsequences of pulses.

In an example embodiment of the first aspect, the drive circuit is configured with the set of subsequences of pulses, and wherein the drive circuit is configured to identify, in the control data stream, the data word corresponding representing one of the differential gates and generate the subsequence of pulses associated with the differential gate represented by the data word.

In an example embodiment of the first aspect, the control data stream represents a plurality of gate sequences, each gate sequence corresponding to one qubit of a set of qubits, and wherein the drive circuit is configured to generate a pulse sequence for each qubit of the set of qubits.

In an example embodiment of the first aspect, the control circuit is configured to generate a plurality of control data streams, each control data stream representing at least one gate sequence, and wherein the apparatus comprises: a plurality of the drive circuits, each drive circuit being configured to receive one of the control data streams from the control circuit, and generate a pulse sequence for at least one qubit, the pulse sequence being based on the at least one gate sequence represented in the control data stream.

In an example embodiment of the first aspect, the control circuit comprises a field-programmable gate array—FPGA—.

In an example embodiment of the first aspect, the at least one drive circuit comprises an application-specific integrated circuit—ASIC—.

In an example embodiment of the first aspect, the pulse sequence is a sequence of 1-bit pulses, and the at least one drive circuit comprises a 1-bit pulse pattern generator.

In an example embodiment of the first aspect, the at least one drive circuit comprises at least one 1-bit digital-to-analog converter—DAC—, each 1-bit DAC being configured to output one of the at least one pulse sequence.

In an example embodiment of the first aspect, the at least one drive circuit comprises a re-clocking circuit, wherein the re-clocking circuit is configured to re-clock the pulse sequence to a clock signal.

In an example embodiment of the first aspect, the re-clocking circuit comprises a flip-flop.

In an example embodiment of the first aspect, the apparatus further comprises a global clock configured to generate the clock signal for the at least one drive circuit.

In an example embodiment of the first aspect, the at least one drive circuit comprises a memory configured to store the pulse sequence.

In an example embodiment of the first aspect, the at least one drive circuit comprises an analog filter configured to shape a spectrum of the pulses of the pulse sequence based on a resonant frequency of the qubit associated with the pulse sequence.

In an example embodiment of the first aspect, the at least one qubit is placed in a cryogenic environment of a quantum computer, and wherein the at least one drive circuit and the control circuit are placed in a non-cryogenic environment of the quantum computer.

According to a second aspect, a quantum computing system comprises at least one apparatus according to the first aspect, and the at least one qubit.

According to a third aspect, a method comprises: receiving a control data stream representing at least one gate sequence for the at least one qubit and generating a pulse sequence for the at least one qubit, the pulse sequence being based on the at least one gate sequence.

Any embodiment may be combined with one or more other embodiments. Many of the attendant features will be more readily appreciated as they become better understood by reference to the following detailed description considered in connection with the accompanying drawings.

### BRIEF DESCRIPTION OF THE DRAWINGS

The accompanying drawings, which are included to provide a further understanding of the example embodiments and constitute a part of this specification, illustrate the example embodiments and together with the description help to explain principles of the example embodiments. In the drawings:

FIG. 1 illustrates a schematic representation of a quantum processing system according to an example embodiment;

FIG. 2 illustrates an example of control data stream;

FIG. 3 illustrates an example pulse sequence;

FIG. 4 illustrates a schematic representation of a quantum processing system according to an example embodiment;

FIG. 5 illustrates a schematic representation of a quantum processing system according to an example embodiment;

FIG. 6 illustrates a method according to an example embodiment;

Like references are used to designate like parts in the accompanying drawings.

### DETAILED DESCRIPTION

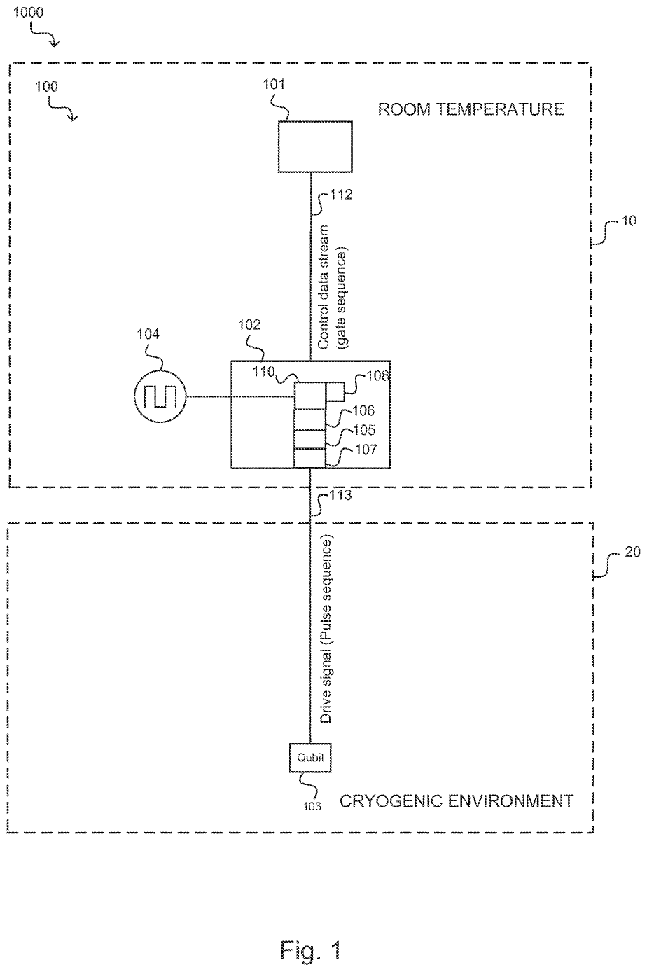

FIG. 1 illustrates an example of a quantum processing system. In this example, the quantum processing system 1000.

The quantum processing system 1000 may comprise a quantum computer or a portion thereof, for example a module, a component, or a set of components configured to be applied at a quantum computer.

A plurality of qubits 103 may reside within the quantum processing system 1000, or outside it, for example due to mechanical, thermal, or fabrication limit related reasons.

A first portion 10 of the quantum processing system 1000 may be located at room temperature. A second portion 20 of the apparatus quantum processing system 1000 may be located at a cryogenic environment at an extremely low temperature.

As used herein, the terms extremely low temperature and cryogenic environment may relate to the required operating temperature of the electronic devices of a quantum processing system of a quantum computer. For example, these terms may relate to the critical temperature of the superconductor materials involved or depend on the thermal energy scales as compared to the quantum energy scales of the quantum electronic components involved. It is however noted that the cryogenic environment may not be initially or permanently cooled to the low temperature. The cryogenic environment may therefore generally comprise a cryogenically coolable environment. The environmental conditions in the cryogenic environment may involve an extremely low temperature, such as for example only a few kelvins, for example 4 K, or even less than one kelvin, for example in the order of millikelvins. The lowest temperature, which may be for example approximately 10 mK, may exist in only a part of the cryogenic environment, as there may be cooled stages of progressively lower temperatures. The qubits 103 may be located for example at a mixing chamber (MXC) stage, which may be at the 10 mK temperature and be the coldest stage of the cryogenic environment. In general, temperature of this stage may be for example above 5 mk and below 100 mK.

As used herein, the term room temperature should not be taken as a limitation that would actually require the environmental conditions in the room temperature environment to correspond to those in rooms where people live and work in. It is more an indication that the conditions do not require cryogenic cooling to the temperatures found in the cryogenic environment. Hence, the room temperature environment of FIG. 1 is provided as an example of a non-cryogenic environment.

The quantum processing system 1000 comprises an apparatus 100 for driving at least one qubit 103 of a quantum computer, also called drive controller. Even though the apparatus 100 has been illustrated to comprise particular components, some of the components may not be present in every embodiment and the apparatus 100 may further comprise components not illustrated in FIG. 1.

The apparatus 100 generates a drive signal for the at least one qubit 103. The drive signal is designed to cause a desired change in the quantum mechanical state of the qubit 103.

Qubit driving may comprise providing a drive signal to at least one qubit 103 of a quantum processing system to implement quantum logic gates. The drive signal may be used to implement any type of quantum logic gate (or quantum gate), and in particular single-qubit gates, two-qubit gates, or multi-qubit gates.

A quantum gate may be implemented by applying a sequence of pulses to the qubit 103. Each pulse induces a coherent rotation in the qubit subspace. In particular, the pulses may realize arbitrary rotations over the Bloch sphere. For a multiple-qubit quantum gate, a different pulse sequence may be applied to each qubit.

The implementation of a quantum gate may be described by at least one sequence of pulses (pulse sequence or pulse train). For a single-qubit quantum gate, the implementation of the quantum gate may be described by one pulse sequence. For a multiple-qubit quantum gate, the implementation of the quantum gate may be described by one pulse sequence for each qubit.

The pulse sequence is a rather redundant signal in terms of information content. As an example, a qubit with a resonance frequency in the order of 5 GHz can be efficiently driven with 25 Gbps bit patterns. This redundancy is physically required to drive the qubits in appropriate manner. However, generating and delivering the pulse sequence to the qubit(s) can require complex qubit control electronics. The cost and power consumption of these complex qubit control electronics limits the scalability of quantum computers.

To improve the power efficiency of the qubit control electronics and therefore the scalability of quantum computers, some embodiments improve the generating and/or delivering of the pulse sequence to the qubit(s). In particular, some embodiments communicate the information required to generate the pulse sequence more efficiently (e.g., in terms of power usage and cost) along the electronics chain.

As illustrated by FIG. 1, the apparatus 100 may comprise a control circuit 101, and at least one drive circuit 102. The control circuit (e.g., FPGA) provides less redundant gate sequence(s) in a control data stream. The at least one drive circuit (e.g., ASIC) generates the pulse sequence(s) based on the gate sequence(s).

The control circuit 101 and drive circuit 102 may be conventional digital circuits as opposed to quantum circuits. The at least one qubit 103 may be placed in a cryogenic environment 20 of a quantum computer. The drive circuit 102 and the control circuit 101 may be placed in a non-cryogenic environment 10 of the quantum computer.

The control circuit 101 comprises at least one communication channel 112 configured to transfer a digital bit stream from the control circuit 101 to the at least one drive circuit 102. The communication channel 112 may refer to a physical transmission medium such as a wire connecting the control circuit 101 to the at least one drive circuit 102, or to a logical connection over a multiplexed medium.

The control circuit 101 is configured to transmit (e.g., in real time) a control data stream to the at least one drive circuit 102 via the communication channel 112. The control data stream represents a gate sequence for the at least one qubit 103 (e.g., in encoded form). The control data stream may be a serial data stream.

The drive circuit 102 is configured to receive the control data stream and generate (e.g., in real-time) the pulse sequence based on the gate sequence included in the control data stream.

Instead of continuously transferring the whole partially redundant pulse sequence (e.g., 25 Gbps bitstream per qubit), the control circuit 101 (e.g., FPGA) transfers the gate sequence at a lower rate (e.g., 100 Mwords/s). The drive circuit 102 generates the pulse sequence based on the gate sequence included in the control data stream.

A quantum gate may be implemented by applying a number of repetitions of one or more subsequence(s) of pulses. Each subsequence of pulses induces a given rotation along a given axis on the Bloch sphere. The repetition of the subsequence(s) accomplishes the corresponding quantum gate.

A subsequence of pulse is typically a short pulse sequence. For example, a subsequence may consist of 35-55 bits. A subsequence may be a scalable leakage optimized pulse sequences (SCALLOPS) subsequences as described in Li, Kangbo, R. McDermott, and Maxim G. Vavilov. “Scalable hardware-efficient qubit control with single flux quantum pulse sequences. ” arXiv preprint arXiv:1902.02911 (2019).

A subsequence typically corresponds to a small negative or positive rotation along the X or Y axis (e.g., dX+, dX−, dY+, dY−). A subsequence may also correspond to an idle sequence which does not cause any net rotation.

The repetition of the subsequence(s) induces a (e.g., negative or positive) rotation along the X or Y axis. For example, if one subsequence causes a rotation of positive 1 degree along the X axis, then to accomplish rotation of 45 degrees along the X axis, the subsequence needs to be repeated 45 times.

X and Y axis are the minimum degrees of freedom required for arbitrary single qubit gates. In some cases, efficiency may be gained by having a negative rotation in addition to a positive rotation.

Typically, four different subsequences (e.g., each described by a bit pattern of at most 32 bits) are sufficient for performing arbitrary gates.

The subsequences may comprise a first subsequence corresponding to a rotation along a first axis, and a second subsequence corresponding to a rotation along the second axis. The first and second subsequences may be separately stored in the memory. Alternatively, the second subsequence may be a bit-shifted version of the first subsequence.

The drive circuit 101 may be configured (e.g., pre-programmed) with the subsequences and optionally the number of repetitions.

The subsequences may be pre-programmed and stored in the drive circuit 102. In particular, the subsequences may be stored in shift registers. The repetitions may be programmed using rules. In particular, the repetitions may be programmed with bit shifts.

The qubit 103 may be driven directly by the drive signal generated by the drive circuit 102. As described in more details in relation to FIG. 3, the drive signal may be a binary (e.g., 1-bit) digital signal. The drive signal is applied directly to the qubit 103 in place of an analog microwave signal. The drive signal may be a simple clocked digital noise shaped signal which may be optimized only for the essential spectral features around the qubit resonant frequency, as opposed to complex analog waveforms.

The drive circuit 102 may comprise a 1-bit pulse pattern generator 110 to generate the drive signal.

An output pulse rate of the pulse pattern generator 110 may be approximatively five times the resonance frequency of the qubit or higher. As an example, a qubit with a resonance frequency in the order of 5 GHz can be efficiently driven with a 25 Gbps pulse rate (e.g., 25 Gsamples/s). The pulse rate does not need to be an exact multiple of the resonance frequency of the qubit. The resonance frequency of the qubit might have some variability as well.

The drive circuit 102 may comprise a 1-bit digital-to-analog converter—DAC—106 configured to output the pulse sequence. The DAC 106 may be a high speed 1-bit DAC. A high-speed DAC typically has an output speed of in the 25 Gbps range or higher. As an example, some analog driving schemes may use 16-bit DACs.

Accomplishing sufficient gate speed and fidelity requires only a modest oversampling ratio (e.g., ratio of 5). As such, the DAC 106 may have a relatively low oversampling rate, for example a ratio of 5.

The drive signal is delivered to the qubit 103 via a transmission line 113. The transmission line may be a coaxial line. The drive signal is applied to the qubit 103 such that the qubit 103 is irradiated with the sequence of pulses. In particular, the drive signal may be applied to the qubit 103 via a capacitive coupler. The capacitive coupler may be designed into the quantum processing unit (QPU). The drive signal may be applied to the qubit 103 via other means such as inductive coupling or a microwave hybrid circuit. The coupling needs to be weak to prevent Purcell decay of the qubit.

Signal processing and generation is distributed to the complexity minimized drive circuit(s) 102 (e.g., ASIC) which utilize bandwidth at room temperature far more efficiently than the control circuit 101 (e.g., FPGA).

The control circuit 101 (e.g., FPGA) may be optimized for the specific driving performed at the drive circuit 102 (e.g., ASIC). In particular, the control circuit 101 may generate a gate sequence optimized for the specific driving performed at the drive circuit 102. For example, if the drive circuit 102 performs SCALLOPS-style driving, the control circuit 101 is optimized for SCALLOPS-style driving. This reduces power consumption and scalability at room temperature.

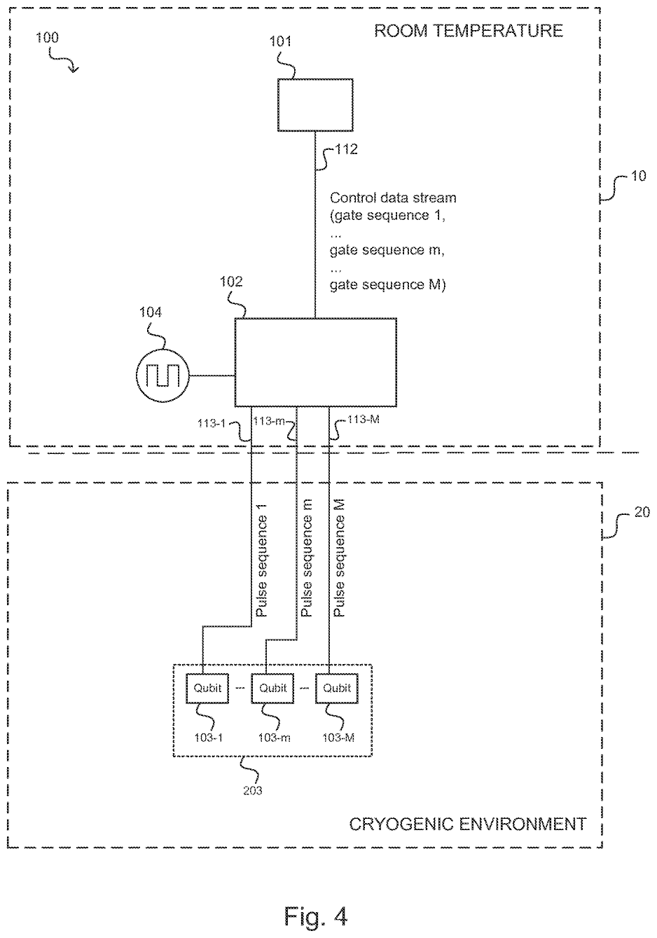

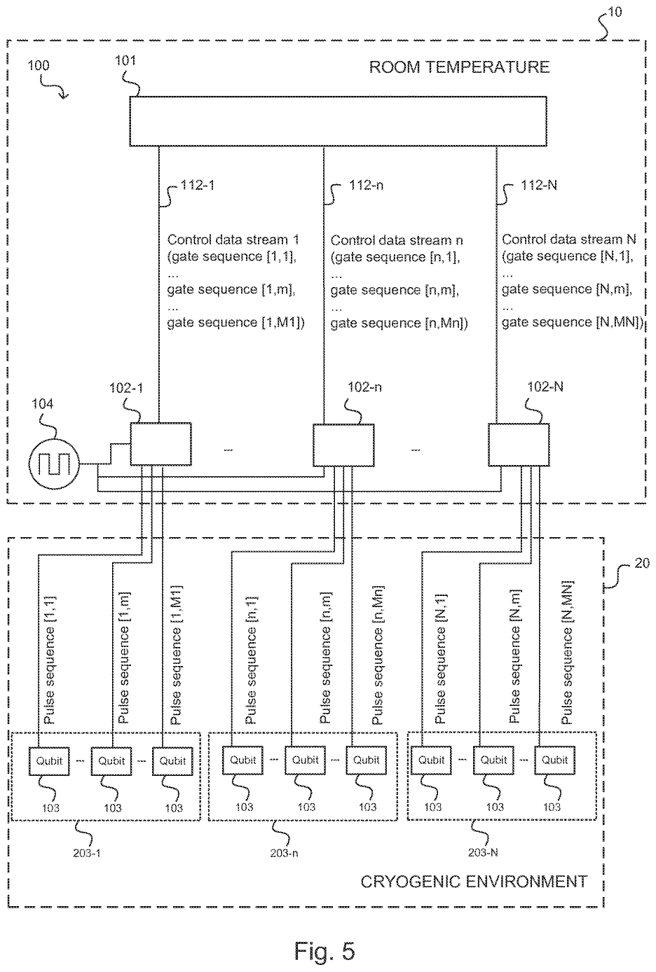

As described in more details in relation to FIG. 4, a single drive circuit 102 may generate a plurality of pulse sequences. Further, as described in more details in relation to FIG. 5, a single control circuit 101 may provide a plurality of control data stream to a plurality of drive circuits 102.

The control circuit 101 (e.g., FPGA) may distribute only the gate sequence(s) in real time. In particular, the control circuit 101 does not need to generate the entire analog waveform since the pulses are generated by the drive circuit 102 (e.g., 1-bit pulse pattern generator). As such, the apparatus 100 can comprise a relatively large pyramid with a single control circuit 101 (e.g., FPGA) at the top, a plurality of qubits 103 at the bottom, and a plurality of drive circuits 102 (e.g., ASICs) in the middle.

The control circuit 101 may be implemented as a general-purpose high-power component such as a field-programmable gate array (FPGA). The drive circuit 102 may be implemented on a low-power component such as an application-specific integrated circuit (ASIC). The drive circuit 101 (e.g. ASIC) may be a special simplified power and phase noise optimized FPGA-like circuit. The drive circuit 101 (e.g., ASIC) may be a specialized ASIC optimized for the specific purpose of scalable power efficient, high-fidelity, low-cost qubit driving.

In at least some embodiments, most of the signal generation is digital. The qubits although being driven by pulses typical of a digital system are nevertheless responding to these signals in an analog manner even if the signals are generated by electronics from mostly digital domain.

The spectral components (and phases) of these digital signals corresponding to the qubit frequency can be controlled in a manner resembling analog in certain respects. The qubit acts as a bandpass filter which responds to average voltages and certain bit patterns in a manner resembling analog which is suitable for QPU control needs.

The manufacturing of high-speed digital ASIC is reliable, mature, and relatively low cost. Further, designing a driver chip for 1-bit schemes such as SCALLOPS is relatively straightforward. Cost, complexity, and power consumption is reduced by the reduction (or lack) of analog radio frequency (RF) electronics and simple logic requirements. Further, accomplishing sufficient gate speed and fidelity requires only a modest oversampling rate (e.g., ratio of 5).

The power consumption of the drive circuit 101 (e.g., ASIC) may be further minimized by minimizing the amount of logic and memory in the drive circuit 101.

The drive circuit 102 (e.g., ASIC) is more energy efficient than the control circuit 101 (e.g., FPGA). As an example, the control circuit 101 (e.g., FPGA) may consume some 10-100 W of power, whereas a single drive circuit 102 (e.g., ASIC) may consume less than 1 W (or even considerably less per single drive line). As such, an apparatus 100 with a single control circuit 101 (e.g., FPGA) and multiple drive circuits 102 (e.g., ASICS) can significantly reduce the overall power consumption.

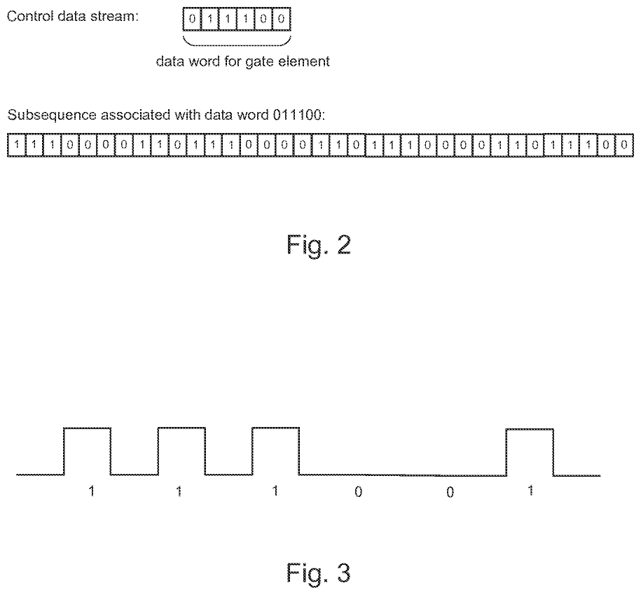

FIG. 2 illustrates an example control data stream. The gate sequence is a sequence of (quantum) gate elements from a set of gate elements. A gate element may be a full quantum gate or a partial quantum gate. A sequence of partial gates can accomplish a full quantum gate. For example, a gate element may be a differential gate corresponding to a single subsequence. A sequence of differential gates can accomplish a full quantum gate.

Each gate element of the set of gate elements is associated with one or more subsequence(s) of pulses of a set of subsequences. Each subsequence of the set of subsequences may be pre-programmed and stored in the drive circuit 102. The drive circuit 102 generates the pulse sequence from the subsequences.

Each gate element is identified by a data word (e.g., code word) in the control data stream. When the drive circuit 102 identifies the data word for a gate element in the control data stream, the drive circuit 102 outputs the one or more associated subsequence(s) of pulses.

The gate sequence is more compact than the pulse sequence. As such, the gate sequence may be communicated in more compressed manner in the control data stream.

If the set of gate elements is small, each gate element can be identified by a data word encoded over a smaller number of bits. The complexity of the drive circuit 102 can be reduced.

If the set of gate elements is large, each gate element must be identified by a data word encoded over a larger number of bits. A large set of gate elements might be more optimal in terms of information bandwidth utilization of the control data stream. The gate elements may correspond to more complicated gate elements. Transferring more bits requires more time or higher throughput. Gate length in real time also depends on the gate (e.g., amount of rotation desired).

The set of gate elements may be a set of constant length subsequences encoded using a constant number of bits. The set of gate elements may be more complex gate elements encoded using more complex control data encoding. The data words encoding the gate elements may be encoded using variable number of bits.

In example embodiments, the gate sequence may be a sequence of full quantum gates. A data word of the control data stream identifies a full quantum gate. Each quantum gate corresponds to a number of repetitions of one or more subsequences of pulses. In some embodiments, the data word may be a 6-bit data word. When the drive circuit 102 identifies the data word for a quantum gate in the control data stream, the drive circuit 102 outputs the associated number of repetitions of the subsequence(s) of pulses.

Each quantum gate may be an elementary quantum gate, such as I, X, Y, Z, H, S and T. For example, the gate sequence for qubit 103 may be a sequence of elementary gate (e.g., HXYIZSTXI). An elementary gate corresponds to a rotation on the Bloch sphere. An elementary gate is defined by an amount of rotation and an axis of rotation.

In example embodiments, the gate sequence may be a sequence of differential gates. The gate sequence indicates which differential gate should be output at a given moment to implement the one or more quantum gates. A data word in the control data stream identifies a differential gate. A differential gate corresponds to a subsequence. In some embodiments, the data word may be a 3-bit data word. When the drive circuit 102 identifies the data word for a differential gate in the control data stream, the drive circuit 102 outputs the associated subsequence of pulses.

The drive signal generated by the drive circuit is a physical pulse sequence, (e.g., a voltage waveform) sensitive to signal fidelity. The gate sequence is communicated from the control circuit to the drive circuit as abstracted code words that are not sensitive to physical signal fidelity.

FIG. 3 illustrates a pulse sequence of an example drive signal. The drive signal is a sequence of 1-bit pulses (1-bit pulse sequence or pulse train). For each bit of the drive signal, a pulse is either applied or not applied to the qubit.

The 1-bit pulse pattern generator 110 may perform noise shaping. Noise shaping may refer to shaping of the (deterministic) noise spectrum associated with digital signals originating a circuit generating only discrete voltage levels. Compared to ideal analog signal, a digital signal contains undesired errors which appear as a noise-like signal when looking at the signal spectrum. How these errors are distributed and how they appear across the spectrum can be modified by selecting the individual pulse positions. The more common engineering context for DAC (Digital-to-analog converter) as well as ADC (Analog-to-digital converter) quantization noise would be delta-sigma modulation which shares some similarities with SCALLOPS. The qubits are sensitive to signals in certain frequency ranges more than in others and undesired signals in certain frequency ranges especially introduce leakage errors. Therefore, noise shaping, or cancellation or in general dealing with the noise in optimal manner can reduce leakage errors.

Digital room temperature driving does not require a precise voltage level for the pulses. As an example, peak voltage may be in a range of 1 V and pulse width may be in a range of 40 ps.

Digital room temperature driving requires reproducibility of the pulse amplitude and length, phase noise, jitter, purity of their spectrum and the SNR (signal-to-noise ratio). These parameters are all related to the precision of the signal the device is capable of outputting, which in turn depends on the final component responsible for the output and the re-clocking of the signal.

Gate fidelity does not appear sensitive to pulse shape. Therefore, it is not necessary to use shaped microwave pulses (e.g., SFQ pulses) for 1-bit driving. There is no need for a superconducting single flux quantum (SFQ) device. The pulses may for example have the shape of a square. The drive circuit 102 may however comprise an analog filter 107 configured to shape a spectrum of the pulses (e.g., based on a resonant frequency of the qubit 103). Analog filters are relatively easy to implement at room temperature and can be further used to optimize the output spectrum of the 1-bit drive.

A potential source of error in pulse-based quantum gates (e.g., SFQ-based gates) is timing jitter of the pulses. The digital drive signal may have large temporal variance (e.g., jitter) and possibly also some amplitude variance (from bit to bit) when arriving at the qubit. If such digital drive signal was directly used to drive the qubits, the qubit gate fidelity would be poor.

To reduce timing jitter of the pulses, the drive circuit 102 may be configured to re-clock the pulses. To that end, the drive circuit 102 may access a clock signal and clock the pulse sequence to the clock signal. In each cycle of the clock signal, a pulse is either applied or not applied to the qubit. The pulse sequence may be clocked at a frequency that is higher than the qubit oscillation frequency (e.g., by a factor 5).

A clock 104 may be configured to generate the at least one clock signal. The clock 104 may be an intrinsically low phase noise external clock. The clock 104 may comprise a precision oscillator. A single global clock 104 may control multiple qubits 103 resonating at a same frequency or distinct frequencies.

The drive circuit 102 may comprise a re-clocking circuit 105 (e.g., d flip-flop). The re-clocking circuit 105 is clocked by the precision oscillator of the clock 104. The re-clocking circuit 105 is configured to synchronize the pulses to the clock signal. The re-clocking circuit 105, although a kind of logic circuit, is optimized to eliminate data jitter (related to phase noise) by gating the transitions to the intrinsically low phase noise external clock 104. Only low phase noise clock sources and microwave generators have low enough jitter. The dedicated re-clocking circuit 105 is placed last after all the logic generating the pulse sequence to clean up the outgoing signal.

The drive circuit 102 (e.g., 1-bit pulse pattern generator) may alternatively have internal re-clocking and may thus be suitable for direct driving of qubits without external re-clocking circuitry. A 1-bit pulse pattern generator with internal re-clocking exhibiting jitter around 200 fs is, according to theory, suitable for driving qubits with 1−F=10⁻⁵.

The drive circuit 102 only needs a small memory to store the subsequences (e.g., 32 bits per subsequence). However, in some embodiments, the drive circuit 102 may comprise a memory 108 (e.g., DDR4 memory chip (4 GB)) configured to store the pulse sequence for a duration of a quantum computation. The memory makes it possible to have fully software defined pulse sequences for the whole duration of the computation. For example, a 4 GB chip allows user to define every single bit at 25 Gbps for a period of approximatively 1.37 s. This allows more optimization options and flexibility for the programmer, especially in the case where active very low latency error correction is not a concern.

As illustrated by FIG. 4, the drive circuit 102 may be configured to drive a plurality of qubits (e.g., simultaneously and/or in parallel).

In that case, the drive circuit 102 is configured to generate a pulse sequence for each qubit of a set 203 of qubits 103-1, 103-m, 103-M. The drive circuit 102 comprises a plurality of transmission lines 113-1, 113-m, 113-M, each line being configured to transmit a pulse sequence to one qubit of the set 203 of qubits 103-1, 103-m, 103-M.

The control data stream comprises (e.g., in encoded form) a gate sequence for each qubit 103-1, 103-m, 103-M of the set 203 of qubits. In particular, the control circuit 101 may transmit the plurality of gate sequences (e.g., one for each qubit of the set 203) in a single serial data stream.

For example, the control data stream comprises gate sequence 1 (e.g., HXYIZSTXI) for qubit 103-1, gate sequence m (e.g., IZSTHXYXI) for qubit 103-m, and gate sequence M (e.g., HYZTSYZIT) for qubit 103-M. The drive circuit 102 generates pulse sequence 1 based on gate sequence 1 (e.g., HXYIZSTXI) for qubit 103-1, pulse sequence m based on gate sequence m (e.g., IZSTHXYXI) for qubit 103-m, and pulse sequence M based on gate sequence M (e.g., HYZTSYZIT) for qubit 103-M.

As illustrated by FIG. 5, the control circuit 101 may be configured to control a plurality of drive circuits 102-1, 102-n, 102-N similar to drive circuit 102 (e.g., simultaneously and/or in parallel). Each drive circuit 102-1, 102-n, 102-N may be configured to drive one or more qubits 103 (e.g., simultaneously and/or in parallel).

The control circuit 101 comprises a plurality of communication channels 112-1, 112-n, 112-N. The control circuit 101 comprises one communication channel 112-1, 112-n, 112-N for each drive circuit 102-1, 101-n, 101-N. The control circuit 101 is configured to generate a control data stream for each drive circuit 102-1, 101-n, 101-N, each control data stream comprising (e.g., in encoded from) the gate sequences for the qubits driven by the corresponding drive circuit 101-1, 101-n, 101-N. Each drive circuit 102-1, 101-n, 101-N receives a control data stream comprising (e.g., in encoded from) the gate sequences for the qubits driven by the drive circuit. Each drive circuit 102-1, 101-n, 101-N generates a drive signal for each of the qubits that it drives based on the corresponding gate sequence.

For example, the control data stream 1 comprises gate sequence gate sequence [1,1] for qubit 103-1-1, gate sequence [1, m] for qubit 103-1-m, gate sequence [1, M1] for qubit 103-1-M1. The control data stream n comprises gate sequence gate sequence [n, 1] for qubit 103-n-1, gate sequence [n, m] for qubit 103-n-m, gate sequence [n, Mn] for qubit 103-n-Mn. The control data stream N comprises gate sequence gate sequence [N, 1] for qubit 103-N-1, gate sequence [N, m] for qubit 103-N-m, gate sequence [N, MN] for qubit 103-n-MN.

The drive circuit 102-1 generates pulse sequence [1,1] for qubit 103-1-1 based on gate sequence gate sequence [1,1], pulse sequence [1, m] for qubit 103-1-m based on gate sequence [1, m], pulse sequence [1, M1] for qubit 103-1-M1 based on gate sequence [1, M1]. The drive circuit 102-n generates pulse sequence [n, 1] for qubit 103-n-1 based on gate sequence gate sequence [n, 1], pulse sequence [n, m] for qubit 103-n-m based on gate sequence [n, m], pulse sequence [n, Mn] for qubit 103-n-Mn based on gate sequence [n, Mn]. The drive circuit 102-N generates pulse sequence [N, 1] for qubit 103-N-1 based on gate sequence [N, 1], pulse sequence [N, m] for qubit 103-N-m based on gate sequence [N, m], pulse sequence [N, MN] for qubit 103-n-MN based on gate sequence [N, MN]. A single control circuit 101 configured to control a N drive circuits, each configured to drive M qubits, can control up to N*M qubits.

Some embodiments improve power efficiency of qubit control electronics in quantum computers. For example, for a gate (change) rate of 200 Mgates/s/channel, for an example set of 64 gates (encoded over 6 bits), the data rate of the control data stream encoding the gate sequences for an example set of 10 qubits is 6 bits at 200 Mbps×10=12 Gbps. As such, a single drive circuit 102 (e.g., ASIC) can generate 10 pulse sequences at 25 Gbps based on a single 12.5 Gbps control data stream from a cost and power optimized control circuit 101 (e.g., FPGA). Each drive circuit 102 (e.g., ASIC) may typically have up to 12 lines to output such pulse sequence. As such, a single 12.5 Gbps control data stream from the control circuit 101 (e.g., FPGA) is sufficient for driving 10 independent qubits.

A single control circuit 101 (e.g., cost optimized FPGA) can typically control 10 drive circuits 102 (e.g., ASICs) each typically capable of driving 10 qubits. As such, a total of 100 qubits could be controlled by a single control circuit 101 (e.g., cost optimized FPGA).

The drive circuit 102 (e.g., ASIC with 1-bit DAC, minimal signal processing, and 25 Gbps output) consumes less power than a direct digital synthesis (DDS) module. In some embodiments, a power reduction of 100:1 compared to current DDS can be expected.

Some embodiments reduce latency. Since the control electronics is at room temperature, slower parallel interfaces (e.g., <1 Gbps/lane) can be used. Such slower parallel interfaces cannot be used between room temperature and cryogenic controller because control wires down the fridge need to be minimized. At room temperature, there are less (or no) limitations on the number of wires that can be used and therefore the number of signals between chips. Slower parallel interfaces have less latency in comparison to fast serial interfaces (e.g., 10 ns vs. 100 ns). This is beneficial in particular for feedback (e.g., due to the way FPGA core logic operates and how high-speed serial interfaces are implemented).

Some embodiments achieve high gate fidelity without compromising gate speed. For example, some embodiments can implement 1-bit driving scheme such as SCALLOPS driving. According to simulations, SCALLOPS can accomplish 99.99% gate fidelity without compromising current gate speeds.

The oversampling ratio of the drive circuit(s) 102 is much lower in comparison to Delta-Sigma with equivalent gate fidelities. For example, SCALLOPS can work with only 5x oversampling ratio. As such, the hardware is easier to implement and consumes less power. Delta-Sigma-DACs are constructed from a 1-bit highly oversampling (e.g., 64x) digital noise shaping DACs with lowpass filters to reconstruct the analog waveform. A benefit of the drive circuit(s) 102 compared to delta-sigma is that the required oversampling ratio in comparison to Delta-Sigma with equivalent gate fidelities is much lower and thus the hardware is easier to implement and consumes less power.

Some embodiments may implement multiple-qubit gates. 1-bit driving of two qubit gates is for example described in Jokar, Mohammad Reza, Richard Rines, and Frederic T. Chong. “Practical implications of SFQ-based two-qubit gates.” 2021 IEEE International Conference on Quantum Computing and Engineering (QCE). IEEE, 2021. In some embodiments, two qubit gates may be implemented with two 1-bit drivers connected to a coupling qubit. In some embodiments, two qubit gates may be implemented with pulse sequences designed to utilize cross resonance effects.

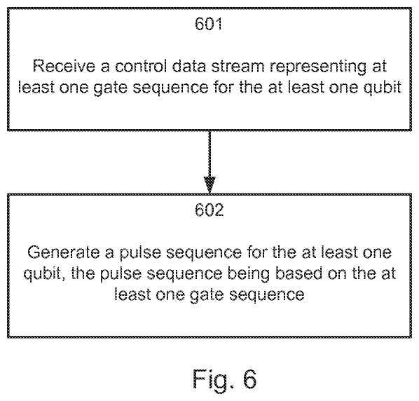

FIG. 6 illustrates an example of a method for driving qubits.

At operation 601, the method comprises receiving a control data stream representing at least one gate sequence for the at least one qubit.

At operation 602, the method comprises generating a pulse sequence for the at least one qubit, the pulse sequence being based on the at least one gate sequence.

Further features of the method directly result for example from the functionalities and parameters of the apparatus 100, and/or the quantum processing System 1000, as described in the appended claims and throughout the specification and are therefore not repeated here. Different variations of the method may be also applied, as described in connection with the various example embodiments. An apparatus may be configured to perform or cause performance of any aspect of the methods described herein. Further, an apparatus may comprise means for performing any aspect of the method(s) described herein.

It is further noted that with the advancement of technology, the example embodiments of the present disclosure may be implemented in various ways. The present disclosure is therefore not limited to the particular examples described above. Instead, implementations may vary within the scope of the claims.

1. An apparatus for driving at least one qubit, the apparatus comprising:
at least one drive circuit configured to
receive a control data stream representing at least one gate sequence for the at least one qubit, and
generate a pulse sequence for the at least one qubit, the pulse sequence being based on the at least one gate sequence.

2. An apparatus according to claim 1, wherein the gate sequence is a sequence of gate elements from among a set of gate elements, wherein each gate element of the set of gate elements is represented by a corresponding data word in the at least one control data stream, and wherein each gate element is associated with one or more subsequences of pulses from among a set of subsequences of pulses.

3. An apparatus according to claim 2, wherein the drive circuit is configured with the set of subsequences of pulses, and wherein the drive circuit (101) is configured to:
identify, in the control data stream, the data word representing one of the gate elements, and
generate the one or more subsequences of pulses associated with the gate element represented by the data word.

4. An apparatus according to claim 1, wherein the control data stream represents a plurality of gate sequences, each gate sequence corresponding to one qubit of a set of qubits, and wherein the drive circuit is configured to
generate a pulse sequence for each qubit of the set of qubits.

5. An apparatus according to claim 1, wherein the apparatus further comprises a control circuit configured to generate the at least one control data stream.

6. An apparatus according to claim 1, wherein the control circuit is configured to generate a plurality of control data streams, each control data stream representing at least one gate sequence, and wherein the apparatus comprises:
a plurality of the drive circuits, each drive circuit being configured to
receive one of the control data streams from the control circuit, and
generate a pulse sequence for at least one qubit, the pulse sequence being based on the at least one gate sequence represented in the control data stream.

7. An apparatus according to claim 6, wherein the control circuit is a field-programmable gate array (FPGA).

8. An apparatus according to claim 7, wherein the at least one qubit is placed in a cryogenic environment of a quantum computer, and wherein the at least one control circuit is placed in a non-cryogenic environment of the quantum computer.

9. An apparatus according to claim 1, wherein the at least one drive circuit is an application-specific integrated circuit (ASIC).

10. An apparatus according to claim 1, wherein the at least one qubit is placed in a cryogenic environment of a quantum computer, and wherein the at least one drive circuit is placed in a non-cryogenic environment of the quantum computer.

11. An apparatus according to claim 1, wherein the pulse sequence is a sequence of 1-bit pulses, and the at least one drive circuit comprises a 1-bit pulse pattern generator.

12. An apparatus according to claim 1, wherein the at least one drive circuit comprises at least one 1-bit digital-to-analog converter (DAC), each 1-bit DAC being configured to output one of the at least one pulse sequence.

13. An apparatus according to claim 1, wherein the at least one drive circuit (102) comprises a re-clocking circuit, wherein the re-clocking circuit is configured to re-clock the pulse sequence to a clock signal.

14. An apparatus according to claim 13, wherein the apparatus further comprises a global clock configured to generate the clock signal for the at least one drive circuit.

15. An apparatus according to claim 1, wherein the at least one drive circuit comprises a memory configured to store the pulse sequence.

16. An apparatus according to claim 1, wherein the at least one drive circuit (102) comprises an analog filter configured to shape a spectrum of the pulses of the pulse sequence based on a resonant frequency of the qubit associated with the pulse sequence.

17. A quantum computing system comprising at least one apparatus according to claim 1, and the at least one qubit.

18. A method comprising:
receiving a control data stream representing at least one gate sequence for at least one qubit, and
generating a pulse sequence for the at least one qubit, the pulse sequence being based on the at least one gate sequence.
